(19) United States
(12) Patent Application Publication
(10) Pub. No.: US 2018/0343326 A1
(43) Pub. Date: Nov. 29, 2018

(54) CAN TO IP INTERNETWORKING

(71) Applicant: Cisco Technology, Inc., San Jose, CA (US)

(72) Inventors: Herbert Wildfeuer, Los Altos, CA (US); Pradeep Kumar Kathail, Los Altos, CA (US); Subhasri Dhesikan, San Jose, CA (US); Raghuram S. Sudhaakar, Fremont, CA (US)

(21) Appl. No.: 15/606,251

(22) Filed: May 26, 2017

(51) Int. Cl. H04L 29/06; H04B 1/54; H04W 72/00

(52) U.S. Cl. CPC H04L 69/18; H04L 69/08; H04Q 2213/13527; H04L 69/161; H04W 72/005; H04B 1/54

(57) ABSTRACT

In one embodiment, a device between a Controller Area Network (CAN)-based network and an Internet Protocol (IP)-based network receives a CAN message from a node in the CAN-based network. The CAN message comprises a CAN message identifier and a data field. The device determines an IP header based on the CAN message identifier and the CAN message. The device converts the data field of the CAN message into an IP message that includes the determined IP header. The device sends the IP message via the IP network to one or more eligible destinations for the IP message.

### TECHNICAL FIELD

The present disclosure relates generally to computer networks, and, more particularly, to a Controller Area Network (CAN) over Internet Protocol (IP) layer architecture and implementation.

### BACKGROUND

Serial networks, such as a Controller Area Network (CAN) bus, are in wide use today across a number of different industries. For example, CAN bus is the predominant networking technology in many vehicles, particularly automobiles. Despite the prevalence of serial networks, such as CAN, in certain industries and products, other networking technologies, such as Ethernet and the Internet Protocol (IP), are heavily dominant in the Information Technology (IT) sector, having caused a strong desire from other industries to migrate non-Ethernet and non-IP networks to standard IT-based technologies for reasons that include speed of innovation, supported bandwidth, device availability, and the like.

The automobile industry has been evolving towards Automated Driver Assistance Systems (ADAS) and self-driving, which requires Ethernet/IP-based networking to support high throughput applications such as video, radar, LIDAR, and infotainment. At the same time, many control systems are still designed with serial interfaces like CAN and cannot move to Ethernet immediately and in mass.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication system;

FIG. 2 illustrates an example network device/node;

FIG. 3 illustrates an example hybrid communication system;

FIGS. 4A-4C illustrate examples of a gateway converting between Controller Area Network (CAN) messages and Internet Protocol (IP) messages; and

FIG. 5 illustrates an example simplified procedure for converting between CAN messages and IP messages.

### DESCRIPTION OF EXAMPLE EMBODIMENTS

### Overview

According to one or more embodiments of the disclosure, a device between a Controller Area Network (CAN)-based network and an Internet Protocol (IP)-based network receives a CAN message from a node in the CAN-based network. The CAN message comprises a CAN message identifier and a data field. The device determines an IP header based on the CAN message identifier and the CAN message. The device converts the data field of the CAN message into an IP message that includes the determined IP header. The device sends the IP message via the IP network to one or more eligible destinations for the IP message.

### Description

A computer network is a geographically distributed collection of nodes interconnected by communication links and segments for transporting data between end nodes, such as personal computers and workstations, or other devices. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. In many cases, the Internet Protocol (IP) is used to convey traffic via a network.

Serial networks are another type of network, different from an IP network, typically forming a localized network in a given environment, such as for automotive or vehicular networks, industrial networks, entertainment system networks, and so on. For example, those skilled in the art will be familiar with the on-board diagnostics (OBD) protocol (a serial network which supports a vehicle's self-diagnostic and reporting capability, including the upgraded “OBD II” protocol), the controller area network (CAN) (or CAN BUS) protocol (a message-based protocol to allow microcontrollers and devices to communicate with each other in applications without a host computer). Unlike an IP-based network, which uses a shared and open addressing scheme, a serial communication network, such as a CAN-based network, generally uses localized and/or proprietary communication standards, where commands or data are transmitted based on localized device identifiers, such as parameter identifiers (PIDs), message identifiers (e.g., CAN MSGIDs), localized station addresses, and so on.

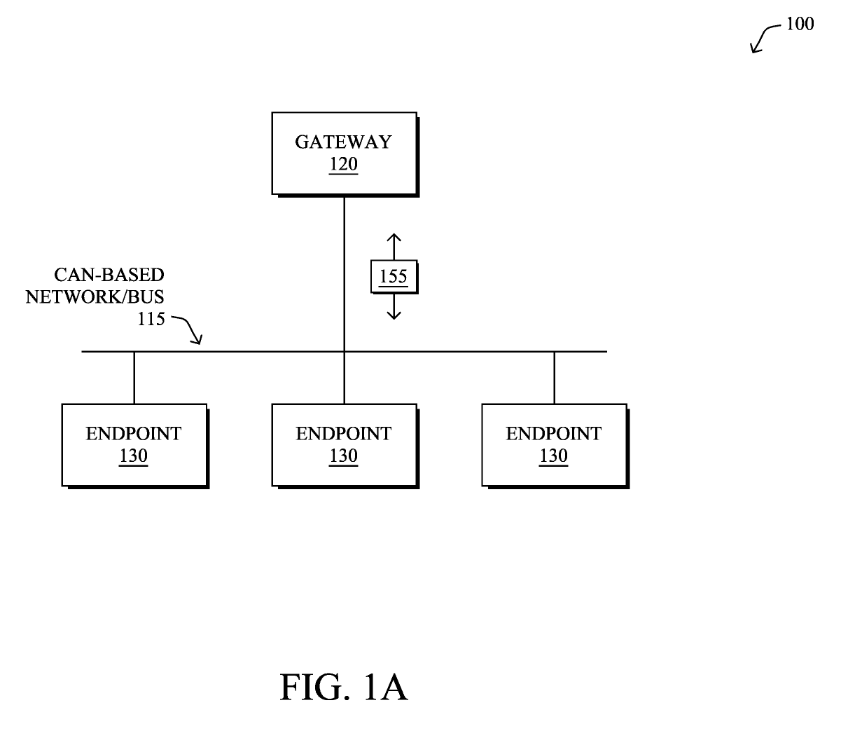

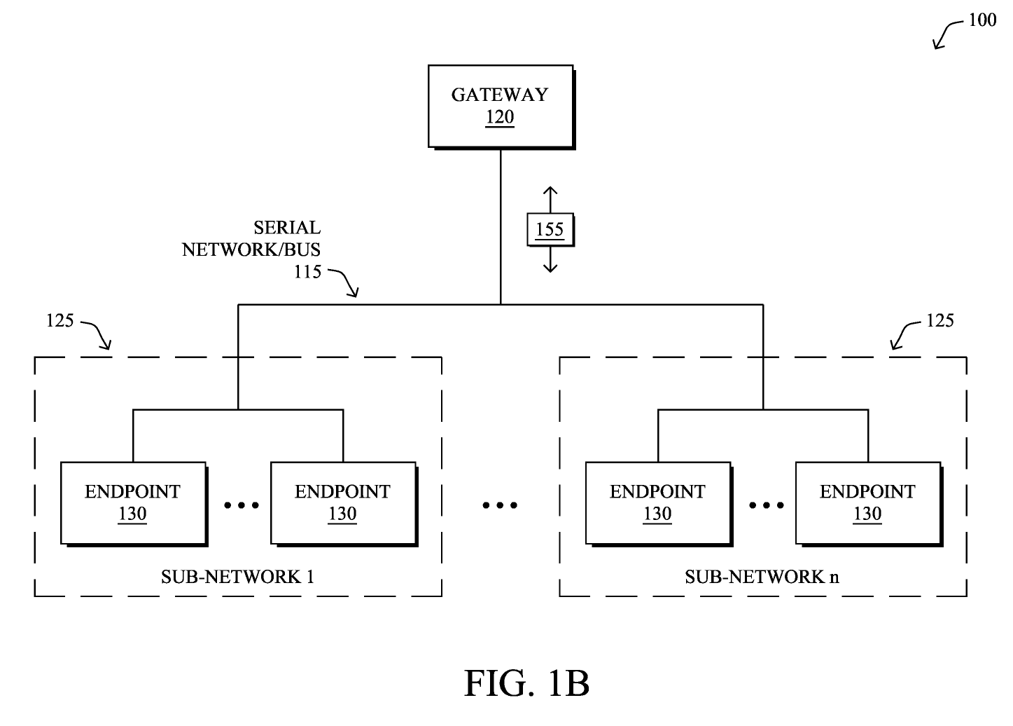

FIG. 1A illustrates an example communication system 100 illustratively comprising a CAN-based network 115 (e.g., a CAN Bus), along with a gateway (or other network device) 120 interconnecting the serial network/bus 115 with one or more other external networks. CAN-based network 115, in particular, illustratively comprises one or more endpoints 130 (e.g., a set of one or more controlled devices, sensors, actuators, controllers, processors, and so on), such as part of a vehicular network, an industrial network, etc. The endpoints may be interconnected by various methods of serial communication. For instance, the CAN-based network 115 may allow the endpoints 130 to communicate serial data 155 (e.g., commands, sensor data, etc.) using predefined serial network communication protocols, such as CAN. In this context, a serial network protocol consists of a set of rules defining how the endpoints 130 interact within the CAN-based network 115.

FIG. 1B illustrates one potential implementation of communication system 100, according to various embodiments. As shown, endpoints 130 may be organized into any number of sub-networks 125 of CAN-based network 115 (e.g., a first through nth sub-network). For example, in the case of a vehicle, the engine control system may be on one sub-network 125, the braking system (e.g., an anti-lock braking system, etc.) may be on another sub-network 125, etc. Each of sub-networks 125 may also provide different levels of performance, in some cases. For example, system critical components may be on a 500 kbps sub-network, whereas non-critical components may be on a 250 kbps sub-network. Interconnecting sub-networks 125 may be gateway 120 and/or any number of gateways that interconnect different sub-networks 125.

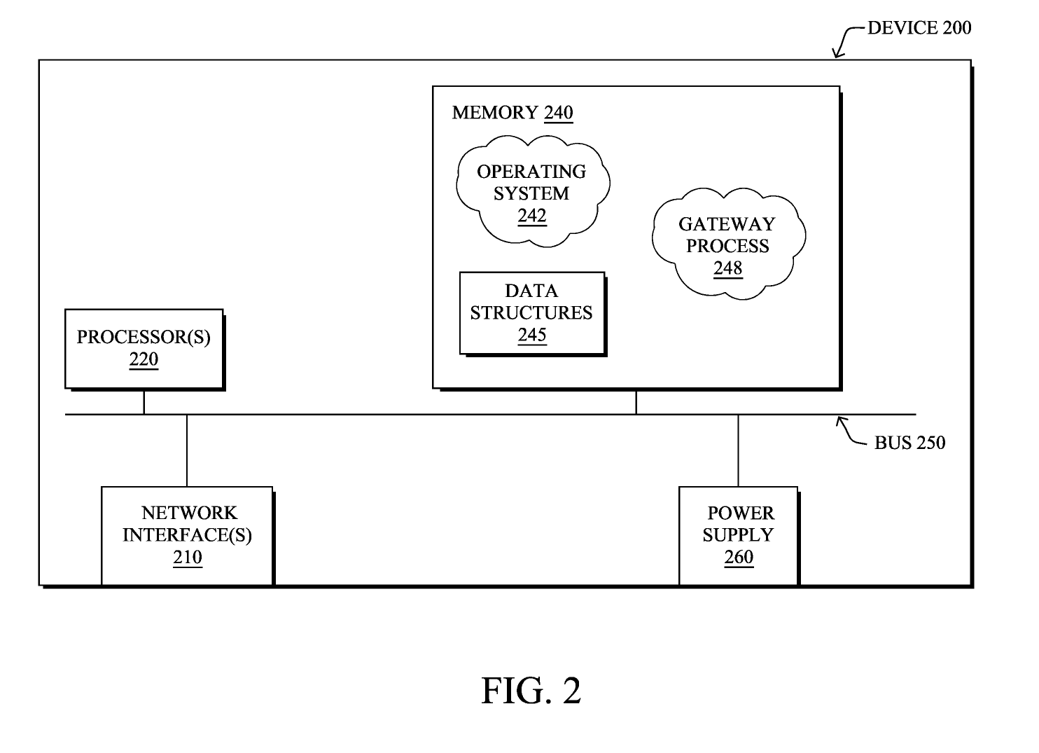

FIG. 2 is a schematic block diagram of an example node/device 200 that may be used with one or more embodiments described herein, e.g., as any of the nodes/devices shown in FIGS. 1A-1B above, particularly as the gateway device 120 or, alternatively, an endpoint 130, or any of the other nodes/devices described below (e.g., a head unit in a vehicle, etc.). The device may comprise one or more network interfaces 210, at least one processor 220, and a memory 240 interconnected by a system bus 250, as well as a power supply 260 (e.g., battery, plug-in, etc.).

In further embodiments, network interface(s) 210 may include the mechanical, electrical, and signaling circuitry for communicating data over links coupled to the serial network 115. Notably, one or more of network interface(s) 210 may be configured to transmit and/or receive data using a serial communication protocol, such as CAN. In additional embodiments, one or more of network interface(s) 210 may be configured to transmit IP-based communications, such as via an IP-based network.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which is typically resident in memory 240 and executed by the processor, functionally organizes the device by, among other things, invoking operations in support of software processes and/or services executing on the device. These software processes/services may comprise an illustrative gateway process 248, as described herein. Note that while gateway process 248 is shown in centralized memory 240 alternative embodiments provide for the process to be specifically operated within the network interface(s) 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above, in general, serial networks, such as a CAN-based networks, are not directly compatible with Ethernet/IP-based networks. In particular, a CAN-based network does not include a network layer in its implementation. As such, there is no addressing information in the CAN frames. Rather, a CAN Message Identifier (MsgID) is the identifying information provided at the application layer and is used for receiving and requesting information between CAN hosts. Information is broadcast over a CAN bus, which may create a concern for security. Similarly, quality of service or service level agreement is not defined by CAN and when a node/device receives multiple messages, it is free to choose the processing order rather than one defined by quality of service parameters. Interworking serial networks with Ethernet/IP-networks enable high throughput applications such as video, radar, LIDAR, infotainment, and the like, to be available as part of the same inter-vehicle network (IVN).

CAN to IP Internetworking

The techniques herein provide an architecture and methodology for interworking a serial network, such as a CAN-based network, with an IP-based network. In some aspects, the techniques herein allow for secure serial data frame and remote frames to be supported between any host on the serial or IP network segments.

Specifically, according to one or more embodiments of the disclosure as described in detail below, a device between a CAN-based network and an IP-based network receives a CAN message from a node in the CAN-based network. The CAN message comprises a CAN message identifier and a data field. The device determines an IP header based on the CAN message identifier and the CAN message. The device converts the data field of the CAN message into an IP message that includes the determined IP header. The device sends the IP message via the IP network to one or more eligible destinations for the IP message.

Illustratively, the techniques described herein may be performed by hardware, software, and/or firmware, such as in accordance with the gateway process 248, which may include computer executable instructions executed by the processor 220 (or independent processor of interfaces 210) to perform functions relating to the techniques described herein.

Operationally, in various embodiments of the present disclosure, for the interworking of serial networking, such as CAN-based networking, with IP-based networking, an interworking layer may be created in which CAN communication packets and IP packets are interconverted. The interworking layer may be created at the gateway where the CAN-to-IP and/or IP-to-CAN conversions may be performed. For example, since CAN is a broadcast network, broadcast capabilities may be recreated in the IP network via multicasting of CAN messages into IP packets using, e.g., multicast addresses and other fields of an IP header generated from the serial message identifier, such as the CAN msgID.

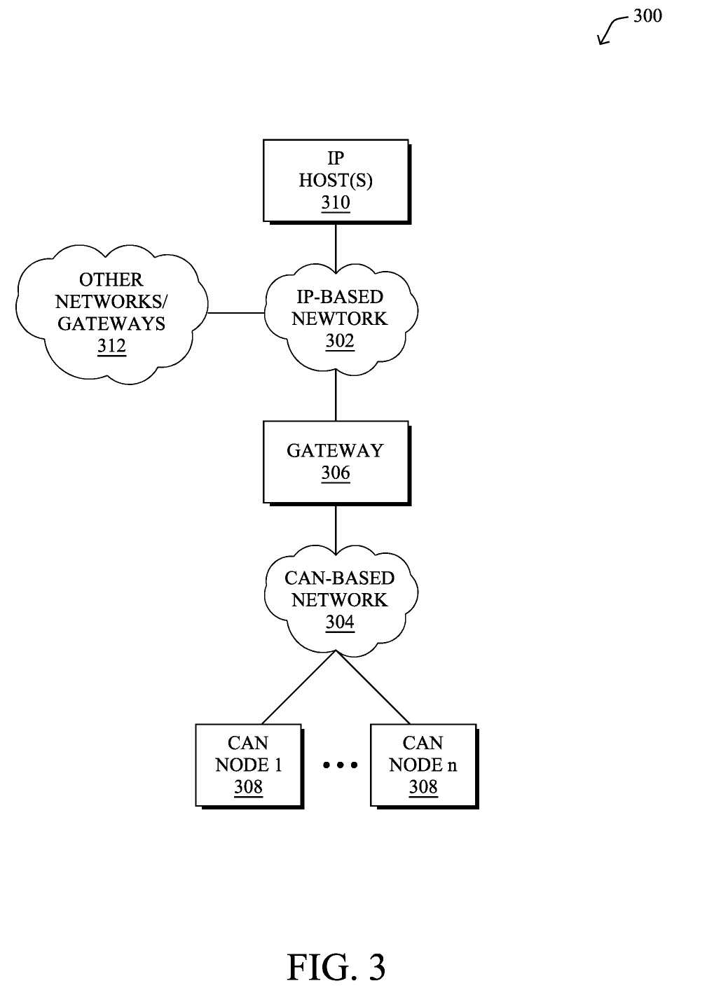

FIG. 3 illustrates an example hybrid communication system 300, in accordance with the teachings herein. As shown, a CAN-based network 304 may be interconnected with an IP-based network 302 via a gateway 306. In general, CAN-based network 304 may include any number of CAN nodes 308 (e.g., a first through nth node). In the context of a vehicle, for example, CAN nodes 308 may include sensors, actuators, control units, such as engine control units (ECUs), or the like.

IP-based network 302 may also include any number of IP hosts 310 configured to communicate via IP-based network 302. In some embodiments, IP-based network 302 may also be connected to any number of other networks/gateways 312. For example, IP-based network 302 may be connected to other IP-based networks, such as the Internet, and/or to other CAN-based networks via IP-CAN gateways that operate in a similar to that of gateway 306 (e.g., by providing an interworking layer between the local CAN-based network and IP-based network 302.

Gateway 306 may be any form of computing device such as, e.g., a device 200 described previously with respect to FIG. 2. For example, in one implementation within a vehicle, gateway device 306 may be implemented as a door control unit (DCU) that acts as a supervisory device over any number of connected CAN nodes 308. Customized software, such as gateway process 248, may be configured to convert CAN messages received from any of CAN nodes 308 via CAN-based network 304 into IP messages for sending via IP-based network 302. Further functionality may also include the ability to convert IP messages received via IP-based network 302 into CAN messages for sending to one or more of CAN nodes 308 via CAN-based network 304.

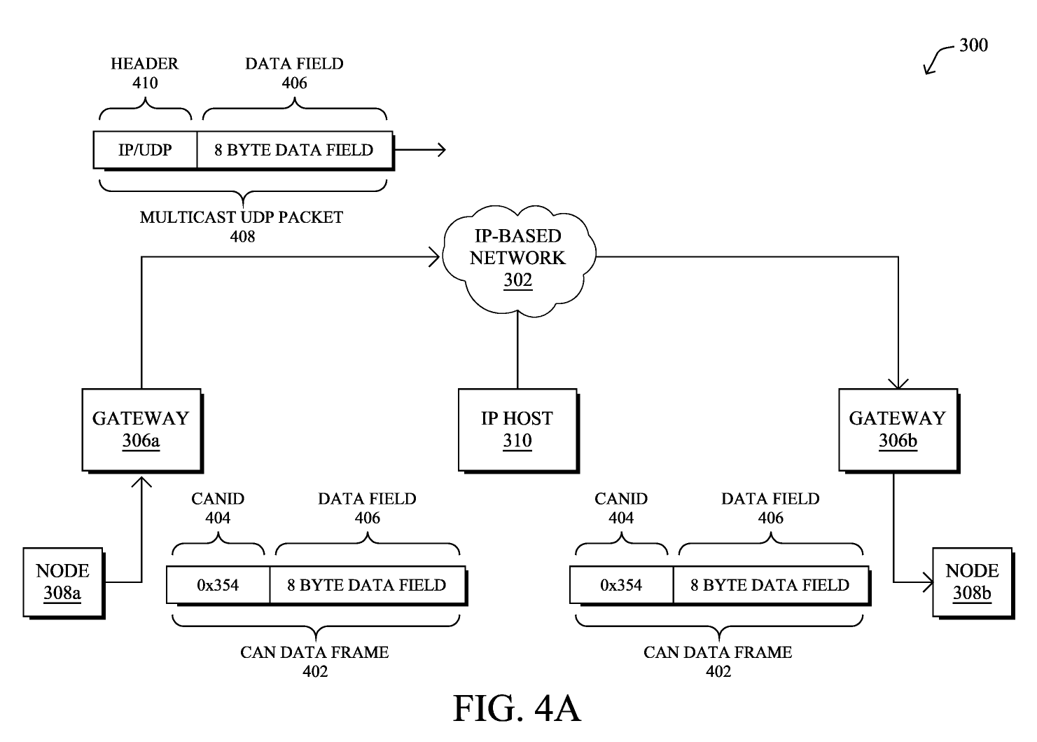

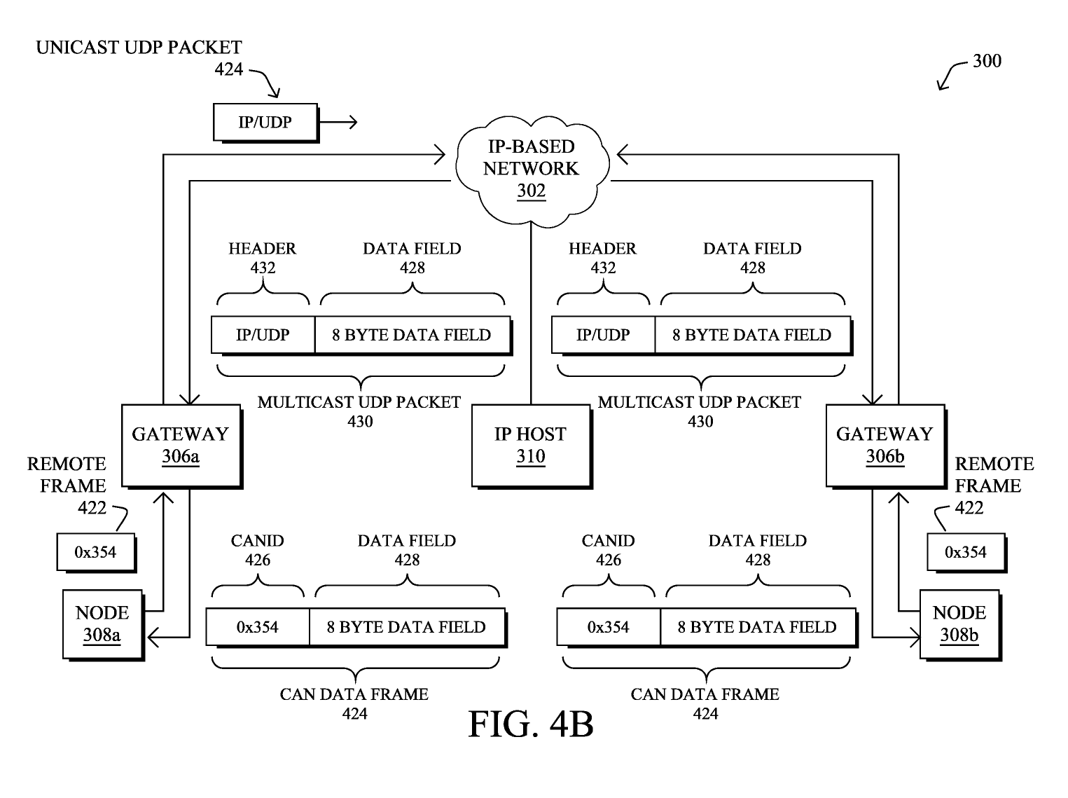

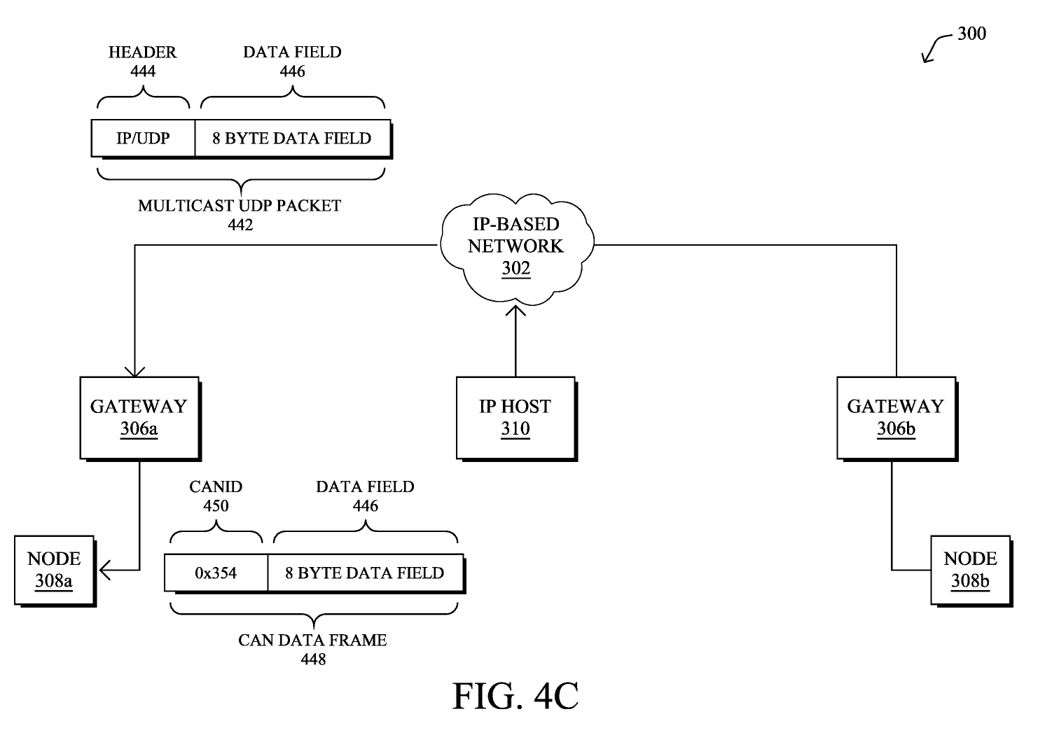

FIG. 4A-4C illustrate examples of a gateway converting between CAN messages and IP messages, and vice-versa, according to various cases that may arise in a hybrid communication system, such as system 300 shown in FIG. 3. Generally, as shown in FIGS. 4A-4C, assume that IP-based network 302 is connected to first and second gateways 306a-306b that, in turn, are each connected to their own respective CAN-based networks. For example, gateway 306a may be connected via a CAN-based network to node 308a and gateway 306b may be connected via another CAN-baed network to node 308b.

As would be appreciated, the number of gateways 306 connected to IP-based network 302, as well as the number of CAN nodes 308 connected to any given gateway 306 may vary and that the configuration shown is illustrative only. In addition, the functions described with respect to a particular one of gateways 306a-306b may also be performed by that of the other gateway 306, in some embodiments. For example, in cases in which the first gateway 306 performs a CAN-to-IP conversion, while the other gateway 306 performs a corresponding IP-to-CAN conversion, it is to be appreciated that the first gateway 306 could also be configured to perform IP-to-CAN conversions, as well. FIG. 4A illustrates a first scenario in which CAN node 308a is to communicate a CAN message to CAN node 308b via the IP-based network 302. In such a case, CAN node 308a may generate and send a, CAN data frame 402 into its local CAN-based network, which is then received by gateway 306a. The CAN data frame 402 may include CANID 404 as a CAN identifier (a CAN msgID) and a data field 406, which may comprise a command, sensor reading, or other such data.

In some embodiments, gateway 306a may convert CAN data frame 402 into an IP message for sending to one or more eligible destinations within IP-based network 302 (e.g., IP host 310, gateway 302b, etc.). Notably, gateway 306a may convert CAN data frame 402 into an IP/User Datagram Protocol (IP/UDP) packet 408 to be multicast to one or more destinations through IP-based network 302. As such, gateway 306 may determine an IP/UDP header 410 that uses the following illustrative addressing scheme:
a source IP address, which is the assigned address of gateway 306a or node 308a;
a source UDP port, which may be random or based on an input file to gateway 306a;
a destination IP address, which may be an address in the multicast IP address space derived from and/or associated with CANID 404, and
a destination UDP port, which may be also derived from CANID 404 (for multiplexed CANIDs over a single multicast address) or random (for non-multiplexed CANIDs).

In this way, the CAN data frame 402, which is effectively broadcast within the local CAN-based network of node 308a, with CANID 404 and data field 406, may be converted by gateway 306a into a multicast IP/UDP packet 408 with header 410 and data field 406 to be communicated through IP-based network 302 to any number of destinations. As would be appreciated, the header information described herein is illustrative only and other variations of the described headers may be used, in further embodiments.

In some embodiments, gateway 306a may also employ a security mechanism, to control which destinations within IP-based network 302 are authorized to receive packet 408. For example, in the case of a vehicle, by controlling the multicast destinations for packet 408, gateway 306a can prevent unauthorized vehicle subsystems from receiving packet 048.

As noted above, header 410 of IP/UDP packet 408 may be generated by gateway 306a to include IP/UDP address and port information derived at least in part from CAN ID 404. In other words, based on the knowledge that node 308a sent CAN data frame 402, gateway 306a may determine the eligible destination(s) for the message outside of the local CAN-based network of node 308a. In some embodiments, header 410 may also include other fields, such as quality of service (QoS) fields that ensure that packet 408 satisfies one or more service level agreements (SLAs) associated with this type of message within IP-based network 302. This parameter may be set by default by gateway 306a, be specified by a user, be based on an input file to gateway 306a, or derived from CANID 404 and/or data field 406. For example, if node 308a is in a relatively high bandwidth CAN-based network, gateway may populate the fields of header 410 to ensure that packet 408 receives a corresponding level of service within IP-based network 302.

Assume now that gateway 306b is an eligible destination for packet 408 and receives packet 408 from IP-based network 302. In turn, gateway 306b may perform the opposite conversion, thereby converting packet 408 back into CAN data frame 402 for transmission within the local CAN-based network of node 302b. For example, based on header 410 of packet 408, gateway 306b may determine CANID 404 and convert packet 408 into CAN data frame 402 with CANID 404 and data field 406. Thus, even though CAN nodes 308a-308b are on different CAN-based networks that are separated by IP-based network 302, they may communicate with one another through the operations of their respective gateways 306.

FIG. 4B illustrates another potential scenario that can be supported by hybrid communication system 300. In particular, in CAN-based networks, another potential message that can be sent into the network is a remote frame. Generally, remote frames are used to request information from a remote node and differ from data frames in that a remote frame instead includes the CANID of the remote node from which data is being sought. In other words, the CANID of a remote frame may be viewed as a remote address. That is, a remote frame is a request for whatever host “owns” that CAN message identifier to broadcast, for example, its current value in a data frame.

To illustrate the remote frame scenario, assume that node 308a generates and sends a remote frame 422 into its local CAN-based network. Remote frame 422 may, in this case, comprise a CANID, which is used to notify node 308b to send its requested data into the network. For example, if node 308b is a sensor, remote frame 422 can be used to request a sensor reading from node 308b. In turn, gateway 306a may determine that node 308a is requesting data from node 308b, which is on a different CAN-based network, based on the CANID included in remote frame 422.

To send remote frame 422 to node 308b, gateway 306a may generate an IP/UDP packet 424 that includes an IP header with the following addressing scheme:
a source IP address, which is the assigned address of gateway 306a or node 308a;
a source UDP port, which may be random or based on an input file to gateway 306a;
a destination IP address, which is the destination IP address of the remote node 308b; and
a destination UDP port, which may also be derived from and/or associated with the CANID (for multiplexed CANIDs over a single unicast address) or random (for non-multiplexed CANIDs).

Similar to the scenario in FIG. 4A, the header of packet 424 may also include QoS parameters that control the service level experienced within IP-based network 302, based, for example, on the CANID of remote frame 422.

Once converted, gateway 306a may send packet 424 to gateway 306b, which uses the header and address information of packet 424 to convert packet 424 back into a CAN remote frame 422. In turn, gateway 306b then sends remote frame 422 into its local CAN-based network, which is received by node 308b.

In response to receiving remote frame 422, node 308b may include its data, such as a sensor reading or the like, within data field 428 of CAN frame 424, which is a CAN data frame. Similar to the operations described with respect to FIG. 4A, CAN data frame 424 may be converted by gateway 306b into a multicast IP/UDP packet 430 with header 432. Also similar to FIG. 4A, the address, QoS, and/or other information in header 432 may be based on CANID 426 of CAN data frame 424 and potentially the contents of data field 428, as well. Finally, in response to receiving packet 430 via IP-based network 302, gateway 306a may perform the IP-to-CAN conversion, thereby converting packet 430 into CAN data frame 424 for sending within the local CAN-based network that includes node 308a. Thus, node 308a is able to receive the information requested using remote frame 422, even though both CAN nodes 308a and 308b are separated by IP-based network 302.

The scenarios presented in FIGS. 4A-4B illustrate messages that originate from CAN nodes. Notably, after conversion from a CAN message into an IP message, the gateway can send the IP message to any number of IP hosts and/or other IP-CAN gateways, for reconversion and retransmission to nodes in other CAN-based networks. FIG. 4C illustrates yet another scenario whereby an IP host 310 is also able to originate messages destined for a CAN node 308.

As shown in FIG. 4C, assume that IP host 310 in IP-based network 302 is to send a message to CAN node 308a. In such a case, IP host 310 may generate such a packet 442 having data field 446 and IP/UDP header 444. Addressing information within header 444 may be achieved as follows:
a source IP address, which is the address of the source IP host 310;
a source UDP port, which may be random or based on predefined input parameters to IP host 310;
a destination IP address, which may be an address associated with gateway 306a or node 308a; and
a destination UDP port, which may also be random or based on predefined input parameters.

Other parameters of header 444 could include, for example, QoS parameters, similar to those described previously.

Once gateway 306a receives packet 442, it may assess the header 444 to determine an appropriate CANID 450. In turn, gateway 306 may convert packet 442 into a CAN data frame 448 that includes data field 446 from packet 442 and also includes the determined CANID 450. The converted CAN data frame 448 is then sent into the local CAN-based network associated with CAN node 308a, thereby allowing CAN node 308a to receive the message sent by IP host 310.

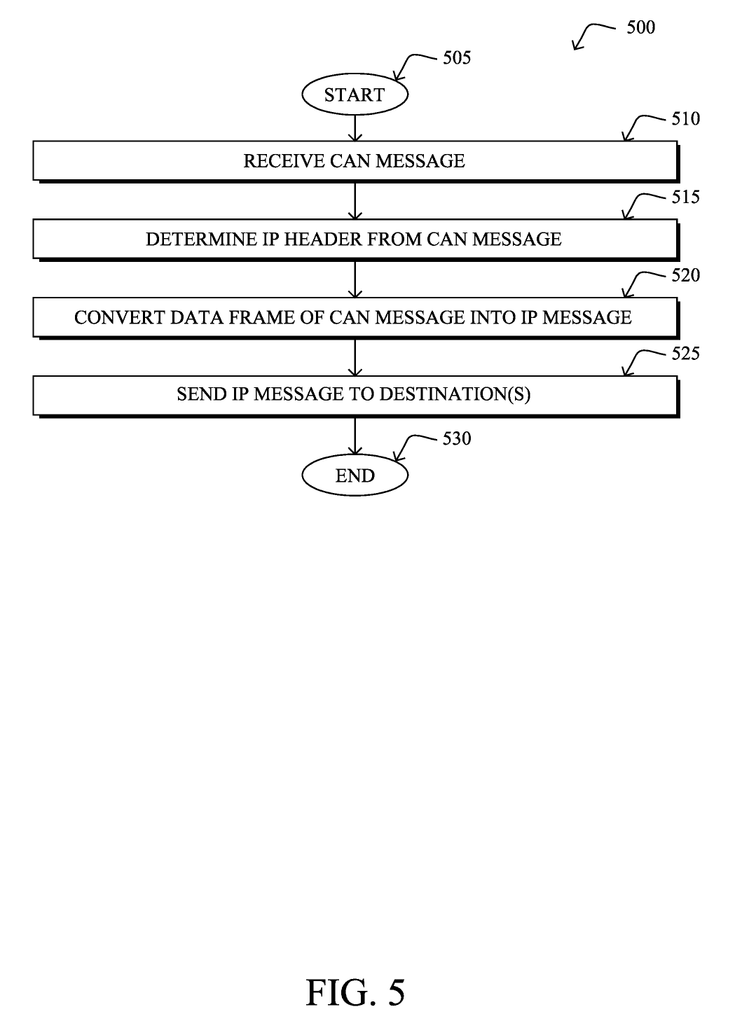

FIG. 5 illustrates an example simplified procedure for converting between CAN messages and IP network messages in a network, in accordance with one or more embodiments described herein. For example, a non-generic, specifically configured device (e.g., device 200), such as a gateway device, may perform procedure 500 by executing stored instructions (e.g., process 248). For example, such a device may be connected to both a CAN-based network and an IP-based network. The procedure 500 may start at step 505, and continues to step 510, where, as described in greater detail above, the device receives a CAN message from one of the nodes in the CAN-based network, such as an ECU. Such a CAN message may comprise, for example, a CAN message identifier (e.g., a CAN MsgID/CANID) and potentially a data field (among other potential fields).

At step 515, as described in more detail above, the device may determine an IP header based on the CAN message identifier and the CAN message. Such a header may, for example, include a multicast IP address that is selected based on the CAN message identifier. In some embodiments, the device may determine and potentially select the multicast address to control which other devices are authorized to receive the associated packet. Further header information may include QoS parameters that control the level of service afforded to the IP packet bearing the header.

At step 520, as detailed above, the device may convert the data field of the CAN message into an IP message that includes the IP header determined at step 515. For example, the device may include the information from the data field of the CAN message in an IP packet that bears the information as part of its payload.

At step 525, the device may then send the IP message to one or more eligible destinations via the IP-based network, as described in greater detail above. Notably, using the address information in the IP header of the IP message, the message may be sent via multicast to one or more destinations, such as other CAN-IP gateways, thereby allowing the IP message to be converted back into a CAN message and transmitted within another CAN-based network. Procedure 500 may then end at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the interworking of serial networks, such as CAN-based networks, with IP networks. All of the serial network capabilities may be used, including data broadcast (push) and data requests (pull). The techniques further allow for network policy and other network security tools (firewall/IDS/IPS) to be applied in the IP network to create a more secure IVN network. In this way, serial networked vehicles may be enabled to more gracefully migrate from CAN hosts to Ethernet/IP hosts over time.

While there have been shown and described illustrative embodiments that provide for converting between serial network messages, such as CAN messages, and IP network messages, it is to be understood that various other adaptations and modifications may be made within the spirit and scope of the embodiments herein. For example, while certain embodiments are described herein with respect to using certain types of serial and IP networks (such as an IVN), the techniques are not limited as such and may be used for other functions, in other embodiments. In addition, while certain protocols are shown, such as CAN, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a device between a Controller Area Network (CAN)-based network and an Internet Protocol (IP)-based network, a CAN message from a node in the CAN-based network, wherein the CAN message comprises a CAN message identifier and a data field;
determining, by the device, an IP header based on the received CAN message identifier and CAN message; ;
converting, by the device, the data field of the CAN message into an IP message that includes the determined IP header; and
sending, by the device, the IP message via the IP-based network to one or more eligible destinations for the IP message.

2. The method as in claim 1, wherein the IP message is an IP/User Datagram Protocol (IP/UDP) message.

3. The method as in claim 1, wherein sending the IP message via the IP-based network to the one or more eligible destinations for the IP message comprises:
multicasting, by the device, the IP message to a plurality of destinations associated with the CAN message identifier, wherein the CAN message identifier identifies the node, and wherein the IP header comprises a multicast IP address.

4. The method as in claim 3, wherein sending the IP message via the IP-based network further comprises:
including, by the device, a quality of service parameter in the IP header of the IP message, wherein the quality of service parameter is associated with the CAN message identifier.

5. The method as in claim 1, wherein at least one of the destinations comprises a second device between the IP-based network and a second CAN-based network, and wherein the second device is configured to convert the IP message into a CAN message that includes the data field and to broadcast the converted CAN message within the second CAN-based network.

6. The method as in claim 1, further comprising:
receiving, at the device, a second IP message via the IP-based network;
determining, by the device, a CAN message identifier from an IP header of the second IP message; and
broadcasting, by the device, a CAN message into the CAN-based network with the CAN message identifier determined from the IP header of the second IP message.

7. The method as in claim 1, further comprising:
receiving, at the device and from a second node in the CAN-based network, a remote frame that requests information from a remote host, wherein the remote frame includes a CAN message identifier;
determining, by the device, an IP header based on the CAN message identifier of the remote frame; and
sending, by the device, a unicast message to a destination associated with the IP header determined based on the CAN message identifier of the remote frame.

8. The method as in claim 1, further comprising:
receiving, at the device, a unicast IP message from the IP-based network;
determining, by the device, that the unicast IP message corresponds to a remote frame;
determining, by the device, a CAN message identifier based on an IP header of the received unicast IP message; and
sending, by the device, the remote frame via the CAN-based network using the determined CAN message identifier based on the IP header of the received unicast IP message.

9. The method as in claim 1, further comprising:
authorizing, by the device, the one or more destinations to receive the IP message.

10. An apparatus, comprising:
one or more network interfaces to communicate with a CAN-based network and an Internet Protocol (IP)-based network;
a processor coupled to the network interfaces and configured to execute one or more processes; and
a memory configured to store a process executable by the processor, the process when executed operable to:
receive a CAN message from a node in the CAN-based network, wherein the CAN message comprises a CAN message identifier and a data field;
determine an IP header based on the received CAN message identifier and CAN message;
convert the data field of the CAN message into an IP message that includes the determined IP header; and
send the IP message via the IP-based network to one or more eligible destinations for the IP message.

11. The apparatus as in claim 10, wherein the IP message is an IP/User Datagram Protocol (IP/UDP) message.

12. The apparatus as in claim 10, wherein the apparatus sends the IP message via the IP network to the one or more destinations associated with the IP address by:
multicasting the IP message to a plurality of destinations associated with the CAN message identifier, wherein the CAN message identifier identifies the node, and wherein the IP header comprises a multicast IP address.

13. The apparatus as in claim 12, wherein the apparatus further sends the IP message via the IP-based network further by:
including a quality of service parameter in the IP header of the IP message, wherein the quality of service parameter is associated with the CAN message identifier.

14. The apparatus as in claim 10, wherein at least one of the destinations comprises a second device between the IP-based network and a second CAN-based network, and wherein the second device is configured to convert the IP message into a CAN message that includes the data field and to broadcast the converted CAN message within the second CAN-based network.

15. The apparatus as in claim 10, wherein the process when executed is further configured to:
receive a second IP message via the IP-based network;
determine a CAN message identifier from an IP header of the second IP message;
remote frame; and
broadcast a CAN message into the CAN-based network with the CAN message identifier determined from the IP header of the second IP message.

16. The apparatus as in claim 10, wherein the process when executed is further configured to:
receive, and from a second node in the CAN-based network, a remote frame that requests information from a remote host, wherein the remote frame includes a CAN message identifier;
determine an IP header based on the CAN message identifier of the remote frame; and
send a unicast message to a destination associated with the IP header determined based on the CAN message identifier of the remote frame.

17. The apparatus as in claim 10, wherein the process when executed is further configured to:
receive a unicast IP message from the IP-based network;
determine that the unicast IP message corresponds to a remote frame;
determine a CAN network message identifier based on an IP address of the received unicast IP message; and
send the remote frame via the CAN-based network using the determined CAN message identifier based on the IP header of the received unicast IP message.

18. The apparatus as in claim 10, wherein the process when executed is further configured to:
authorize the one or more destinations to receive the IP message.

19. A tangible, non-transitory, computer-readable medium storing program instructions that, when executed by a processor of a device between a Controller Area Network (CAN)-based network and an Internet Protocol (IP)-based network to perform a process comprising:
receiving, at the device, a CAN message from a node in the CAN-based network, wherein the CAN message comprises a CAN message identifier and a data field;
determining, by the device, an IP header based on the CAN message identifier and the CAN message;
converting, by the device, the data field of the CAN message into an IP message that includes the determined IP header; and
sending, by the device, the IP message via the IP-based network to one or more eligible destinations for the IP message.

20. The computer-readable medium as in claim 19, wherein the IP message is an IP/User Datagram Protocol (IP/UDP) message.
